(19) United States
(12) Patent Application Publication
(10) Pub. No.: US 2011/0168210 A1
(43) Pub. Date: Jul. 14, 2011

(54) MICRO-NANO BUBBLE GENERATING METHOD, MICROCHANNEL CLEANING METHOD, MICRO-NANO BUBBLE GENERATING SYSTEM, AND MICROREACTOR

(75) Inventors: Kazuaki TABATA, Kanagawa (JP); Masato MIKAMI, Kanagawa (JP); Masaki HIROTA, Kanagawa (JP)

(73) Assignee: FUJI XEROX CO., LTD., Tokyo (JP)

(21) Appl. No.: 12/196,783

(22) Filed: Aug. 22, 2008

(30) Foreign Application Priority Data
Oct. 24, 2007 (JP) 2007-275991

(51) Int. Cl. B08B 9/027; F15D 1/00

(52) U.S. Cl. 134/22.11; 137/13; 137/561 R

(57) ABSTRACT

A micro-nano bubble generating method comprises: introducing a liquid into a microchannel, in which the microchannel is defined by a microchannel wall an entirety or a portion of which is formed by a porous wall having through pores with radii of 10 to 1,000 nm; and supplying a gas directly into the microchannel from outside the porous wall by a pressurized-gas supplying section, to allow micro-nano bubbles to be contained in the liquid.

### CROSS-REFERENCE TO RELATED APPLICATIONS

This application is based on and claims priority under 35 USC 119 from Japanese Patent Application No. 2007-275991 filed Oct. 24, 2007.

### BACKGROUND

(i) Technical Field

The present invention relates to a micro-nano bubble generating method, a microchannel cleaning method, a micro-nano bubble generating system, and a microreactor.

(ii) Related Art

In recent years, a cleaning effect based on micro bubbles is expected in the semiconductor industry.

If miniaturized elements or devices typified by microreactors, which are fabricated by utilizing micromachining and are devices for performing reaction in microscale channels with equivalent diameters of 500 μm or less, are applied to techniques for effecting, for example, the analysis, synthesis, extraction, or separation of materials, numerous advantages can be obtained in such as production of a large variety of products in small lots, high efficiency, and a low environmental load. Therefore, in recent years, expectations are placed on the application of such miniaturized elements or devices to various fields

Microreactors are often fabricated from such materials as glass, plastics, metal, and silicone.

As the related-art methods of cleaning microchannels, a method in which a solvent such as water is allowed to flow under pressure to wash away deposits, and a method in which a microreactor body is placed in an ultrasonic cleaner, and cleaning is effected while applying pressure with a syringe or the like, are known.

### SUMMARY

According to an aspect of the invention, there is provided a micro-nano bubble generating method comprising: introducing a liquid into a microchannel, in which the microchannel is defined by a microchannel wall an entirety or a portion of which is formed by a porous wall having through pores with radii of 10 to 1,000 nm; and supplying a gas directly into the microchannel from outside the porous wall by a pressurized-gas supplying section, to allow micro-nano bubbles to be contained in the liquid.

### BRIEF DESCRIPTION OF THE DRAWINGS

Exemplary embodiments of the present invention will be described in detail based on the following figure, wherein:

FIG. 1 is a schematic diagram illustrating an example of a microreactor which has a confluent channel in which three channels converge and which can be used in a micro-nano bubble generating method and the like in accordance with the invention;

FIG. 2 is a schematic diagram illustrating an example of a cover for forming a porous wall of the microreactor which has the confluent channel in which the three channels converge and which can be used in the micro-nano bubble generating method and the like in accordance with the invention;

FIG. 3 is a schematic diagram illustrating an a-a′ cross section of the microreactor shown in FIG. 1;

FIG. 4 is an enlarged view of the porous wall which can be used in the micro-nano bubble generating method and the like in accordance with the invention;

FIG. 5 is a schematic diagram illustrating an example of the micro-nano bubble generating method and the like in accordance with the invention;

FIG. 6 is a schematic diagram illustrating an example of a microreactor which has a Y-type confluent channel and which can be used in the micro-nano bubble generating method and the like in accordance with the invention;

FIG. 7 is schematic diagram illustrating a portion of a cross section of a microchannel 32f of the microreactor which has a Y-type confluent channel and which can be used in the micro-nano bubble generating method and the like in accordance with the invention;

FIG. 8 is a schematic diagram illustrating an example of a microreactor which has an I-type channel and which can be used in the micro-nano bubble generating method and the like in accordance with the invention;

FIG. 9 is a schematic diagram illustrating an example of a cover for forming a porous wall of the microreactor which has the I-type channel and which can be used in the micro-nano bubble generating method and the like in accordance with the invention;

FIG. 10 is a schematic diagram illustrating a cross-section of the microchannel during the reaction operation in the microreactor which has the I-type channel and which can be used in the micro-nano bubble generating method and the like in accordance with the invention;

FIG. 11 is a schematic diagram illustrating a cross-section of the microchannel during the cleaning operation in the microreactor which has an I-type channel and which can be used in the micro-nano bubble generating method and the like in accordance with the invention;

FIG. 12 is a schematic diagram illustrating an example during the reaction operation in the microreactor which has the I-type channel and which can be used in the micro-nano bubble generating method and the like in accordance with the invention (a base material 50a and a cover 50c are represented in an overlapping manner); and

FIG. 13 is a schematic diagram illustrating an example during the cleaning operation in the microreactor which has the I-type channel and which can be used in the micro-nano bubble generating method and the like in accordance with the invention (the base material 50a and the cover 50c are represented in an overlapping manner).

### DETAILED DESCRIPTION

The micro-nano bubble generating method in accordance with the invention includes the steps of: introducing a liquid into a microchannel; and supplying a gas directly into the microchannel from outside a porous wall having through pores with radii of 10 to 1,000 nm formed in the entirety or a portion of a microchannel wall by a pressurized-gas supplying section, to thereby allow micro-nano bubbles to be contained in the liquid. It should be noted that, in the invention, the porous wall and the pressurized-gas supplying section in combination will also be referred to as a “micro-nano bubble generating system.”

Hereafter, a detailed description will be given of the invention.

### <Microchannel>

In the invention, the microchannel is an extremely small flow channel, and its width is synonymous with several micrometers to several thousand micrometers (not less than several micrometers and not more than several thousand micrometers; hereafter, unless otherwise specified in the notation of other numerical ranges, the same holds true). It should be noted that although, in the invention, the microchannel refers to a microscale flow channel, but is meant to include a millimeter scale flow channel as well.

The channel width may be selected, as required, but is preferably 10 to 1,000 μm, more preferably 20 to 500 μm.

In the invention, since the microchannel is of a micro scale, its size and velocity of flow are both small, and the Reynolds number of a fluid flowing through the microchannel becomes 2,300 or less. Accordingly, the microchannel device of the invention having the microscale channel is not a turbulent flow-dominant device but a laminar flow-dominant device.

Here, the Reynolds number (Re) is defined by the following formula, and the laminar flow is dominant when the Reynolds number is 2,300 or less.

Re=uL/ν

(u: velocity of flow, L: representative length, ν: coefficient of kinetic viscosity)

In the invention, a plurality of fluids may be sent through the microchannel while forming a laminar flow. In that case, the microreactor should preferably have a confluent portion where two more fluids sent from a plurality of fluid inlet ports meet to form a laminar flow. In addition, in the invention, the microchannel has one or more outlet ports and is preferably provided with a plurality of outlet ports corresponding to the laminar flow

In the invention, the microchannel is a flow channel having an extremely small diameter and isolated from the outside by a base material. The base material may be a baseboard or may have a tubular shape, but is preferably formed in the shape of a baseboard.

In addition, the cross-sectional shape of the microchannel is not particularly limited, and any shape may be used. As the cross-sectional shape of a plane perpendicular to the channel axis of the microchannel, it is possible cite a circular shape, an elliptical shape, a quadrangular shape, a triangular shape, other polygonal shape, a potbellied shape, and the like, but the invention is not limited to the same. Among these, the cross-sectional shape of the microchannel is preferably a quadrangular shape (rectangular shape) in view of the ease of fabrication.

In addition, in the invention, the axial shape of the channel is not particularly limited, and any shape such as a linear shape, a curvilinear shape, and the like. Here, the axial shape of the channel section the shape of an axis in the flowing direction of the fluid in the microchannel.

As described above, the axial shape of the channel is not particularly limited, but in order to secure a channel length with respect to a fixed area, it is preferable to form a bent portion or portions for changing the direction of the microchannel.

The method of forming the microchannel is not particularly limited, and it is possible to use a known method, for example. The microchannel can be fabricated by a micro-machining technique, for example. The micro-machining techniques include, for instance, electroforming, the LIGA (lithographic galvanoforming abforming) technique using X-rays, a method in which resist portions are used as structural body portions by photolithography, a method in which resist openings are subjected to etching process, micro-electro-discharge machining (μ-EDM), laser machining using a YAG laser, a UV laser, or the like, and mechanical micro-cutting such as an end mill using micro-tools made of hard materials such as diamond. Any of these techniques can either be used by itself or in combination.

### <Porous Wall>

A description will be given of a porous wall having through pores with a radius of 10 to 1,000 nm, which is formed in the entirety or a portion of a microchannel wall.

The “microchannel wall” means a material which partitions the surroundings of the microchannel. In addition, the “porous wall” means a material having a multiplicity of pores (through pores) penetrating between two opposing two surfaces of a material.

The aforementioned porous wall allows only a gas to percolate through the through pores but does not allow a liquid to percolate therethrough due to the surface tension of the through pores.

An example of calculation of pressure required for allowing water to percolate through the through pore is shown below. From the Young-Laplace equation shown below, the pressure required for allowing water to percolate through the through pore was calculated (Proceeding of MicroTAS 2006, pp. 245-247, Proceedings of the Ted-Cof, 2001, JSME).

P_{B}=2ν·cos θ/R

(P_{B}: pressure counterbalancing the surface tension, ν: surface tension, R: radius of the through pore)

In the calculation, the liquid was assumed to be water, and the surface tension of water was set to 72.75 nN/m. In addition, the material of the porous wall was assumed to be alumina, and the calculation was made by assuming the water-repellent angle of alumina to be 30°. The results are shown in Table 1.

TABLE 1

| Radius | Pressure | | | |
|---|---|---|---|---|
| of | Counterbalancing | Atmospheric | Differential | Applied |
| Through | Surface | Pressure | Pressure | Pressure |
| Hole (nm) | Tension (MPa) | (MPa) | (MPa) | (MPa) |
| 0.5 | 2.52 × 10² | 1.01 × 10⁻¹ | 2.52 × 10² | 2.52 × 10² |
| 1 | 1.26 × 10² | 1.01 × 10⁻¹ | 1.26 × 10² | 1.26 × 10² |
| 10 | 1.26 × 10¹ | 1.01 × 10⁻¹ | 1.25 × 10¹ | 1.27 × 10¹ |
| 25 | 5.04 | 1.01 × 10⁻¹ | 4.94 | 5.14 |
| 50 | 2.52 | 1.01 × 10⁻¹ | 2.42 | 2.62 |
| 75 | 1.68 | 1.01 × 10⁻¹ | 1.58 | 1.78 |
| 100 | 1.26 | 1.01 × 10⁻¹ | 1.16 | 1.36 |
| 250 | 5.04 × 10⁻¹ | 1.01 × 10⁻¹ | 4.03 × 10⁻¹ | 6.05 × 10⁻¹ |
| 500 | 2.52 × 10⁻¹ | 1.01 × 10⁻¹ | 1.51 × 10⁻¹ | 3.53 × 10⁻¹ |
| 1000 | 1.26 × 10⁻¹ | 1.01 × 10⁻¹ | 2.47 × 10⁻² | 2.27 × 10⁻¹ |
| 2500 | 5.04 × 10⁻² | 1.01 × 10⁻¹ | −5.09 × 10⁻² | 1.52 × 10⁻¹ |
| 5000 | 2.52 × 10⁻² | 1.01 × 10⁻¹ | −7.61 × 10⁻² | 1.27 × 10⁻¹ |

For example, in a case where the radius of the through pore is 100 nm, from the results of Table 1, water cannot percolate through the through pore unless it is pressurized to approx. 1.36 MPa (approx. 13.4 atm) or higher.

The radius of the through pore formed in the porous wall is 10 to 1,000 nm, preferably 10 to 500 nm, more preferably 10 to 100 nm. In a case where the radius of the through pore is greater than 1,000 nm, if the pressure counterbalancing the surface tension is lower than 1.01×10⁻¹ MPa, i.e., the atmospheric pressure, (in a case where the radius is greater than 1.24 μm from the Young-Laplace equation), the liquid is likely to leak through the through pore. Meanwhile, in a case where the radius of the through pore is less than 10 nm, very large pressure is required at the time of generating nano bubbles and is difficult to handle. When the through pore diameter becomes nearly equal to the surface roughness of a surface where the through pore is not formed, such as the channel wall surface (generally, the surface roughness (Ra) of a thin film member is on the order of several nanometers or thereabouts), the accuracy of the Young-Laplace equation becomes distorted, so that it becomes impossible to control the corrosion of the liquid level as designed.

As the porous wall, a porous body which is obtained by anodic oxidation or the like is preferable, and anodized alumina (porous alumina) and anodized silicon (porous silicon) are more preferable. In addition, anodized alumina is more desirable in view of the pore diameter size, controllability, and the like. Apart from these, a member obtained by subjecting an existing material to fine pore machining is preferable. In addition, also by taking into consideration the process of channel formation, it is preferable to have a soft metal such as Au or Cu, which facilitates room-temperature bonding, to be coated and carried on the surface of the porous wall.

The member which forms the channel by being bonded or adhered to the porous wall is preferably a material suitable for room-temperature bonding which will be described later. Specifically, it is possible to cite metals such as Au, Al, Ni, and Cu, an alloy such as stainless steel, nonmetals such glass, a ceramic, and silicon. An even more preferable form includes a plate member and a thin film, such as a glass plate, in which a plastically deformable metal such as Au or Cu is coated on a laminating surface of each member.

Furthermore, polydimethylsiloxane and the like can also be used favorably since they are easily formed, have an adsorption effect, and can be connected to the porous wall merely by pressure bonding without an adhesive or the like.

The method of fabricating the porous wall is not limited, and it is possible to use a known method. However, it is possible to cite semiconductor fabrication techniques including fine pattern forming techniques such as photolithography, sputtering process, anodic oxidation, Sol-Gel process, a method in which two or more kinds of organic polymers having different thermal stability are mixed and dispersed, and a more thermally unstable organic polymer is decomposed, a partial thermal decomposition method of an organic block copolymer, and the like. Among these, a semiconductor fabrication technique such as photolithography, sputtering process, and anodic oxidation are preferable since they are capable of fabricating regular through pores, and anodic oxidation is more preferable.

The anodic oxidation is preferable since it is capable of controllably forming in a large area a structure having nano-size through pores. As a structure having the nano-size through pores, for instance, an aluminum coating subjected to anodic oxidation (hereafter, referred to “anodized aluminum coating” as well) is known.

In the invention, the porous wall is preferably formed by the anodized aluminum coating. The anodized aluminum coating is obtained by subjecting an aluminum film formed on an aluminum plate or substrate to anodic oxidation in an acidic electrolyte.

This anodized aluminum coating has a specific geometric structure in which columnar through pores with radii of several nanometers to several hundred nanometers are said to be arrayed in parallel at intervals (cell size) of several tens of nanometers to several hundred nanometers. In a case where the pore interval is several tens of nanometers or more, this columnar through pore has a high aspect ratio and also excels in the uniformity of the radius of the cross section. The radius and interval of this through pore can be controlled by regulating the kind of acid and the voltage used in anodic oxidation. For example, if the voltage in anodic oxidation is lowered, the interval between the through pores can be decreased.

Also, similar pores can be formed with respect to silicon.

The thickness (depth of the through pore) of the anodized aluminum coating is controllable by controlling the time period of anodic oxidation. In the invention, the thickness (depth of the through pore) of the anodized aluminum coating is preferably 10 to 500 μm, more preferably 20 to 400 μm, even more preferably 30 to 300 μm.

A description will be given below of an example of the method of fabricating the anodized aluminum coating.

After a high-purity aluminum foil (99.99%, made by Aldrich) was degreased in acetone by using an ultrasonic cleaner as pretreatment prior to anodic oxidation, the aluminum foil was subjected to heat treatment for 3 hours at 400° C. in a nitrogen atmosphere. Further, the aluminum foil after heat treatment was subjected to electrolytic polishing in a solution of HClO₄ (70%): CH₃CH₂OH (95%)=1:5, at a 8° C. temperature and an 18 V voltage (>150 mA/cm²).

The aluminum foil after the aforementioned pretreatment was subjected to anodic oxidation twice (hereafter, referred to as the “primary oxidation” and “secondary oxidation”). In the case where only the primary oxidation is provided, the pores formed in the surface are irregular; however, by carrying out the secondary oxidation after removing the stage of these irregular pores, it is possible to form an anodized aluminum coating in which the pores are regularly arrayed. In the anodic oxidation, a 15 wt. % sulfuric acid electrolyte was used for 1 to 20 V, a 0.3M phosphoric acid electrolyte was used for 1 to 20 V, and a 0.3M oxalic acid electrolyte was used in the other ranges. After the primary anodic oxidation, the irregularly grown anodized aluminum coating was removed by heating at 60° C. by using chromic acid (1.8 wt. %) and sulfuric acid (6 wt %). After the secondary anodic oxidation, the residual aluminum was removed by using a saturated mercury chloride solution, and thin films (barrier layers) remaining at the bottoms of the formed pores were removed by using sulfuric acid (5 wt. %), thereby forming the through pores. For details concerning the method of fabrication of anodized aluminum coating, reference can be had to “Application of Anodic Aluminum Oxide for Nanoparticles Filter and Catalytic Support” (Materials Integration, Vol. 18, No. 1 (2005), pp. 48-53).

In addition, it is also possible to preferably use as the porous wall Monotran Film (made by Nac Co.) in which a multiplicity of through pores are provided in a macromolecular film such as polypropylene, polyethylene terephthalate, or the like.

### <Pressurized Gas Supplying Section>

The micro-nano bubble generating method in accordance with the invention includes the step of supplying a gas directly into the microchannel by a pressurized-gas supplying section, to thereby allow micro-nano bubbles to be contained in the liquid.

The “pressurized-gas supplying section” is not limited insofar as it is capable of supplying a gas into the microchannel through the porous wall, but it is possible to preferably illustrate a chamber having a pressurizing and/or depressurizing section. In the case where the chamber has not only the pressurizing section but also the depressurizing section, the operation of deaerating the liquid within the microchannel through the porous wall becomes also possible, so that it is preferable.

In the supply of the pressurized gas, a microreactor provided with a microchannel having a porous wall is installed in a chamber, and the interior of the chamber is hermetically sealed, an arbitrary gas is filled within the chamber, and the pressure within the chamber is set to the pressure within the microchannel or higher, thereby making it possible to supply the arbitrary gas into the channel through the porous wall as micro-nano bubbles. Since the aforementioned gas percolates through the through pores with radii of 10 to 1,000 nm and is supplied into the liquid within the microchannel, it is possible to form microchannels having radii corresponding to the radii of the through pores.

The step of allowing the micro-nano bubbles to be contained in the liquid should preferably include the step of applying ultrasonic waves to the liquid within the microchannel by an ultrasonic transducer. For example, as shown in FIG. 5, it is preferable to install an ultrasonic transducer 15 on a reverse surface (a side opposite to the surface where the channel is formed) of a substrate in which the microchannel is formed, to thereby apply ultrasonic waves to the liquid being sent into the microchannel. The ultrasonic transducer 15 should preferably be detachable.

In a case where the gas, which was dissolved in the liquid due to the cavitation generated by the ultrasonic waves, is precipitated and forms bubbles, which is therefore preferable.

### <Micro-Nano Bubbles>

In the invention, the term “micro-nano bubbles” is a generic term including micro bubbles and nano bubbles, and it preferably has an average diameter of several nanometers to several hundred nanometers, more preferably several nanometers to several tens of micrometers, even more preferably several nanometers to several hundred nanometers.

A powerful cleaning effect and/or bactericidal effect is noted for the micro-nano bubbles, but its effect is generally stronger in nano bubbles than in micro bubbles. According to the Young-Laplace equation (Δp=2σ/r, Δp: pᵢ (pressure within the bubble)−p₀ (external pressure), σ: interfacial tension, r: radius of the bubble), in the nano bubble with a diameter of 100 nm, the differential pressure becomes 30 atm. Accordingly, when the nano bubble collapses when coming into contact with an object, a jet of several tens of atmospheric pressure is produced, so that the cleaning effect of the object surface can be expected.

In addition, since an excess amount of free energy at an interface between two different phases is the adsorbability at the interface, the nano bubble, whose specific surface area is far larger than the micro bubble and whose total free energy is larger than the same, more effectively adsorbs contaminants in water. Accordingly, the nano bubbles are conceivably effective in the removal of contaminant components in water.

Furthermore, as a result of calculation of molecular dynamics concerning water droplets on the nanometer order, it is anticipated that the probability of existence of hydrogen atoms on the gas side is high due to the interaction of hydrogen bonding of water. This is conceivably applicable to nano bubbles as well, and the probability of existence of hydrogen atoms on the gas side, i.e., on the inner side of the bubbles, is high. Namely, it is conceived that, in bubbles with diameters of several nanometers, the polarity of the gas-liquid interface is aligned. Accordingly, electrical separation similar to soap can be realized at the gas-liquid interface by the nano bubbles, so that the cleaning promotion effect and the electrostatic bactericidal effect are expected to be provided by virtue of the electrostatic effect at the interface.

In addition, in the gas phase-liquid phase reaction, since micro-nano bubbles are easily dissolved and/or dispersed in a liquid, reaction with a component in a solution is facilitated, and the reactivity is high. In the micro-nano bubble generating method in accordance with the invention, an arbitrary gas and an arbitrary liquid can be used depending on the objective.

The amount of supply of the micro-nano bubbles can be adjusted in accordance with the objective and is not limited, but it is preferable to supply micro-nano bubbles corresponding to 0.1 to 30 vol. % of a unit volume of the liquid introduced into the microchannel, and it is more preferable to supply micro-nano bubbles corresponding to 7 to 14 vol. % of the unit volume. If the amount of supply of the micro-nano bubbles is within the above-described range of numerical values, nano bubble water exhibiting high activity can be obtained, so that it is favorable.

### <Microchannel Cleaning Method>

The liquid containing the micro-nano bubbles obtained by the micro-nano bubble generating method in accordance with the invention can be used in cleaning the interior of the microchannel as a cleaning liquid. The microchannel cleaning method in accordance with the invention is characterized by including the steps of: preparing a cleaning liquid containing micro-nano bubbles by the above-described micro-nano bubble generating method; and effecting cleaning and/or sterilization (hereafter, the “cleaning and/or sterilization” will also be referred to as “cleaning or the like”) of the interior of the microchannel by causing the cleaning liquid to pass through the microchannel.

According to the invention, since cleaning or the like is effected by introducing a cleaning liquid containing micro-nano bubbles into the microchannel, the cleaning or the like is possible without disassembling the device having the microchannel. In addition, by repeatedly effecting the cleaning or the like of the microchannel by the cleaning method of the invention, as required, it becomes possible to repeatedly use the microchannel for an extended period of time, so that it is favorable.

As the liquid used in the cleaning liquid preparing step, it is possible to cite water, an acid, an alkaline aqueous solution, a dispersion liquid of alcohol, and the like, and water among them is preferable, and water at pH 7 to 8 is more preferable. The temperature of the fluid used in cleaning is not particularly limited, but it is preferable to select a temperature suited for removal of contaminants. In addition, it goes without saying that a temperature at which component members of the microreactor will not be damaged should be selected.

### <Gas>

In addition, in the above-described cleaning liquid preparing step, the gas which is formed into micro-nano bubbles, i.e., the gas which is supplied by the pressurized-gas supplying section, is preferably at least one gas selected from the group consisting of air, oxygen, ozone, and the like in the case where the cleaning or the like of the microchannel is the objective. Oxygen or ozone is more preferable, and ozone is even more preferable.

### <Applications of Cleaning Method>

The microchannel cleaning method in accordance with the invention can be suitably used in the method of cleaning a microchannel formed in a device selected from the group consisting of, for example, a food processing device, a pharmaceutical product processing device, and a chemical reaction device.

### <Microreactor>

The microreactor in accordance with the invention has the above-described micro-nano bubble generating system. The microreactor which can be used in the invention has at least one microchannel having the micro-nano bubble generating system, and may further has a channel branch, a confluent portion, other microchannel, and the like. Further, as the cleaning section, in addition to the micro-nano bubble generating system, a section that applies pressure to the fluid by a syringe or a pump, or a known cleaning section of such as ultrasonic cleaning, may be used in combination.

In addition, the microreactor which can be used in the invention may have portions having the functions of reaction, mixing, separation, refining, analysis, cleaning based on other method, and the like.

The microreactor which can be used in the invention may be provided, as required, with such as a liquid inlet portion for sending a fluid into the microreactor and an outlet port for discharging the fluid from the microreactor, for example.

In addition, the microreactor which can be used in the invention is able to suitably structure a microchemical system by combining a plurality of microreactors or by being combined with devices having the functions of such as reaction, mixing, separation, refining, and analysis, or with a liquid feeding device, a collecting device, other microreactors, and the like, depending on the application.

The size of the microreactor can be set appropriately according to the objective of use, but a range of 1 to 100 cm² is preferable, and a range of 10 to 40 cm² is more preferable. In addition, the thickness of the microreactor is preferably in the range of 0.5 to 30 mm, more preferably in the range of 1.0 to 15 mm.

### <Microreactor Manufacturing Method>

A description will be given of a microreactor manufacturing method in accordance with the invention.

The method for connecting the substrate having the microchannel formed therein and the substrate having a porous wall is not be limited, and a known method can be used, but should preferably be room-temperature bonding.

The room-temperature bonding refers to the direct bonding of atoms at room temperature, and is a bonding method in which after oxide films and impurities on the surfaces of members to be bonded are removed to clean their surfaces by such as neutral atomic beam, ion beam, and fast atom bombardment (FAB) treatment in a vacuum, their activated clean surfaces are abutted against each other to be thereby bonded.

According to the room-temperature bonding, it is possible to obtain a high-accuracy microreactor in which variations of the shape and thickness of composite layers are small, so that it is favorable. In addition, since heating is not required, firm bonding can be easily obtained for materials whose coefficients of thermal expansion are different.

As materials for use in room-temperature bonding, it is possible cite metals such as Al, Ni, Cu, and stainless steel (SUS) and nonmetals such as a ceramic and silicon.

### EXAMPLES

Hereafter, a detailed description will be given of the invention with reference to examples. However, the invention is not to be limited to the below described examples, and various modifications are possible within the scope of the invention. In addition, component elements of the examples can be arbitrarily combined within the scope of the invention.

### <Manufacture of Sodium Hydrogen Carbonate>

NaCl+NH₃+H₂O+CO₂→NH₄Cl+NaHCO₃↓ (a)

The reaction of the equation (a) is a reaction in which the ammonia soda process (i.e., a method of manufacturing sodium carbonate, also known as Solvay process) is stopped midway.

After the reaction of the equation (a), precipitated particles of NaHCO₃ are sufficiently cleaned by diffusion based on a laminar flow, and are used in applications such as pharmaceutical use, food use, etc.

A description will be given below of cases (Examples 1 and 2) in which a microreactor having a three-way confluent channel is used in the mixing of an NaCl aqueous solution, an NH₄OH aqueous solution, and CO₂ and a case (Example 3) in which an NaCl aqueous solution and an NH₄OH aqueous solution are mixed by using a microreactor having a Y-channel, and CO₂ is supplied into the channel from a cover having a porous wall which is used at the time of cleaning as well.

### Example 1

### (1) Configuration of Microreactor Having a 3-Way Confluent Channel

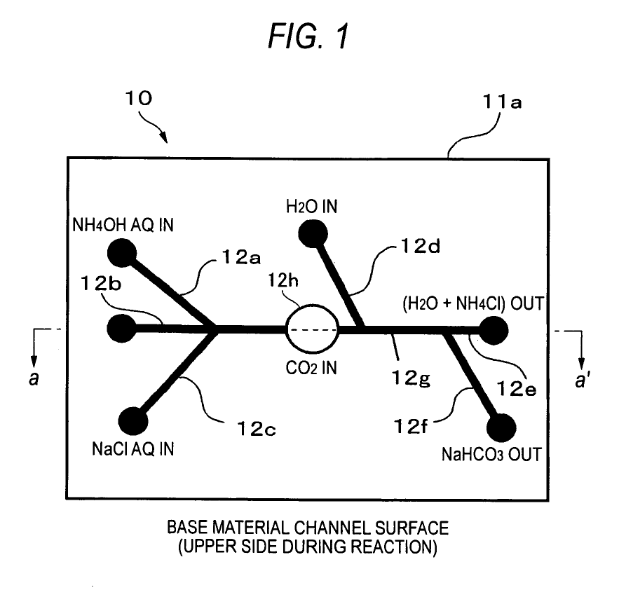

A description will be given of a microreactor 10 having a 3-way confluent channel shown in FIGS. 1 to 3.

As for the base material of the microreactor 10, a stainless baseboard (whose surface was Au plated (not shown) with a thickness of 30 μm) of 50 mm×30 mm×3 mm was used as a base material 11a shown in FIG. 1, and microchannels 12a to 12d having fluid inlet ports, microchannels 12e to 12f having outlet ports, and a microchannel 12g having an exhaust port 12h penetrating through the base material 11a were formed by etching.

The microchannels 12a to 12f were provided with a channel width of 250 μm and a depth of 100 μm, and the microchannel 12g was provided with a channel width of 500 μm and a depth of 100 μm.

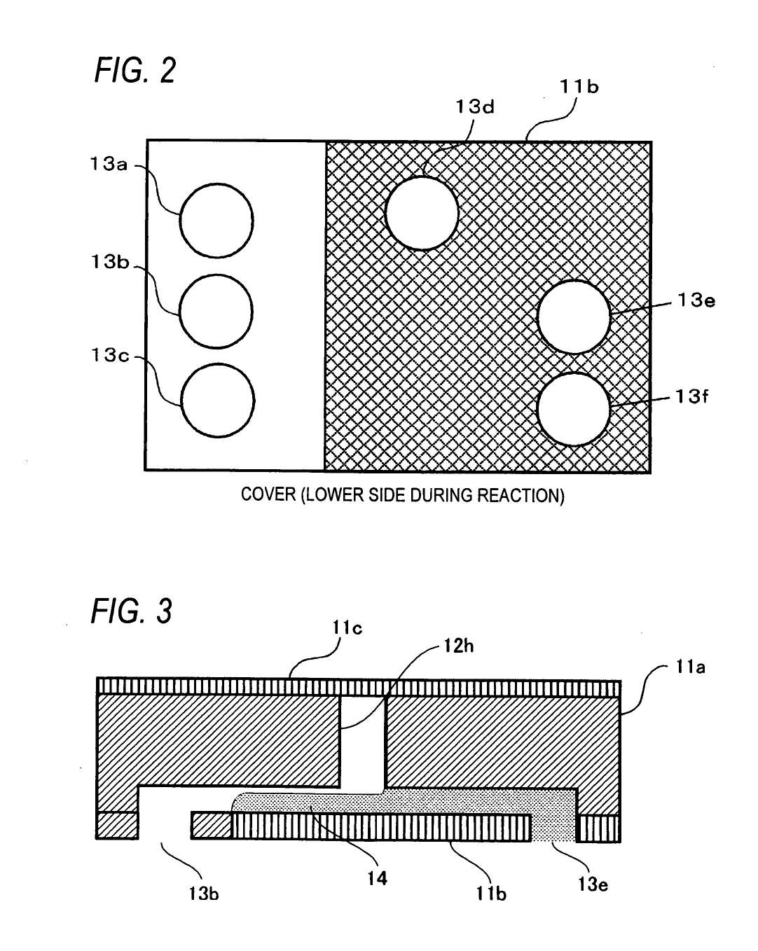

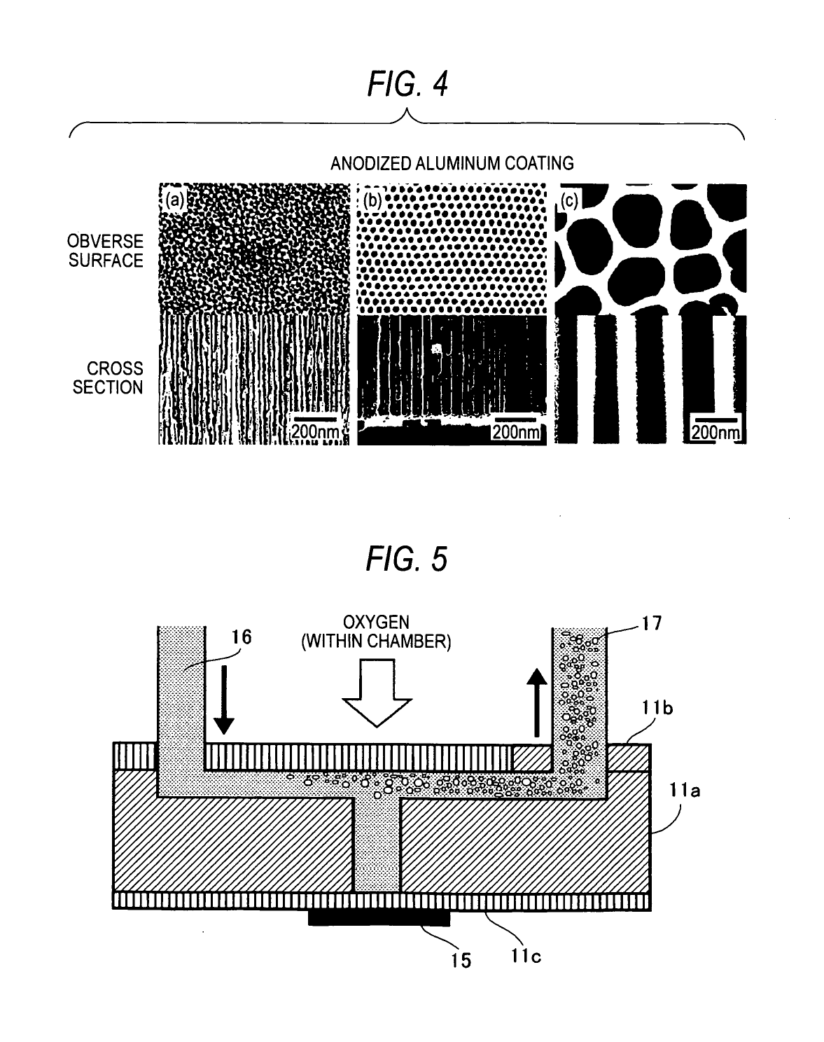

Of the anodized aluminum coatings shown in FIGS. 4A to 4C, the one (with a through pore radius of 50 nm, and thickness of 100 μm) shown in FIG. 4B was used as a cover 11b shown in FIG. 2. The method of fabrication of the anodized aluminum coating is as described before. The anodization was carried out by effecting treatment for 10 hours at an applied voltage of 150 V by using 1 wt. % phosphoric acid solution as an electrolyte.

As the cover 11b, the one in which fluid inlet ports 13a to 13d and outlet ports 13e and 13f corresponding to the fluid inlet ports and outlet ports of the microchannels 12a to 12f were formed, as shown in FIG. 2, was used. In addition, the cover 11b partially having a porous wall was used so that the CO₂ gas did not leak through the porous wall until the channels converged when the CO₂ gas was supplied through the microchannel 12b.

As a cover 11c shown in FIG. 3, one (Monotran Film (made by Nac Co.)) having a porous wall on its overall surface was used.

Next, the base material 11a having the microchannels formed therein was disposed in a lower stage within a vacuum tank, and the cover 11b with the anodized aluminum coating was disposed in an upper stage within the vacuum tank. Subsequently, the interior of the vacuum tank was evacuated to set a high vacuum state or in an ultra-high vacuum state. Next, the lower stage was relatively moved with respect to the upper stage to cause the base material 11a to be located immediately below the cover 11b such that the positions of the fluid inlet ports and the outlet ports are aligned with each other. Then, the surface of the base material 11a and the surface of the cover 11b were irradiated with an argon atom beam to clean the surfaces.

Next, the upper stage was lowered, and the base material 11a and the cover 11b were pressed under a predetermined load (100 kgf/cm²) for a predetermined time period (e.g., 5 min.) to thereby bond the base material 11a and the cover 11b at room temperature. In this example, the base material 11a and the cover 11c were bonded to each other by using an adhesive.

### (2) Manufacture of Sodium Hydrogen Carbonate

Sodium hydrogen carbonate was manufactured by using the microreactor 10 by the following operation. In Example 1, the microreactor 10 was used by setting the cover 11b on the lower side such that CO₂ after the conversion of the gas introduced through the microchannel 12b and the liquid does not leak through the porous wall cover.

The CO₂ gas was sent from the fluid inlet port of the microchannel 12b at a flow rate (10 to 60 ml/h). At the same time, an NH₄OH aqueous solution (0.1 mol/l) was sent from the fluid inlet port 13a of the microchannel 12a, and an NaCl aqueous solution (0.1 mol/l) was sent from the fluid inlet port 13c of the microchannel 12c both at a flow rate (10 to 60 ml/h) by the use of syringe pumps, respectively. As shown in FIG. 3, the CO₂ gas introduced from the fluid inlet port 13b formed in the cover 11b and sent from the microchannel 12b percolated through the outlet port 12h formed in a central portion of the base material 11a and the porous wall of the cover 11c, and was discharged to outside the channel.

After the reaction shown in the equation (a), precipitated particles of sodium hydrogen carbonate were sufficiently cleaned by a laminar flow formed by distilled water introduced from the fluid inlet port 13d of the microchannel 12d at a flow rate (50 to 250 ml/h) by using a syringe pump, and a liquid containing the cleaned particles of sodium hydrogen carbonate was collected at the outlet port 13f at a terminal end of the microchannel 12f.

### (3) Cleaning of Microchannels

After the microreactor 10 after use was set in the chamber, as shown in FIG. 5, and oxygen was filled in the chamber, the pressure within the chamber was adjusted to 15 Mpa.

A cleaning liquid 16 (composition: distilled water at pH=approx. 8) was sent from the microchannels 12a to 12d at a flow rate (60 to 2,400 ml/h) by syringe pumps. Oxygen in the form of micro-nano bubbles was supplied to the cleaning liquid 16 through the porous wall. As a result of the fact that the cleaning liquid 16 was sent until the flow of the cleaning liquid 16 containing micro-nano bubbles 17 stabilized, it was possible to remove contaminants (not shown) in the microchannels and deposits (not shown) on the microchannel wall.

### Example 2

In Example 1, the microreactor (not shown) was fabricated in the same way as in Example 1 except that the bonding of the base material 11a and the cover 11b was effected not by room-temperature bonding but by bonding using an adhesive.

As the base material 11a, a SUS plate in which the channels were formed in the same way as in Example 1 was prepared, and a cover with an anodized aluminum coating was prepared as the cover 11b. After the base material 11a and the cover 11b were opposed to each other and alignment was carried out, an instant adhesive (LOCTITE WIDE, made by CEMEDINE Co., Ltd.) was applied evenly on portions other than the channels on the base material 11a side by using a dispenser. The opposed base material 11a and cover 11b were brought into pressure contact, and were left to dry for one hour in the atmosphere, thereby obtaining the microreactor of Example 2. As a result of conducting operation similar to that for Example 1, results similar to those of Example 1 were obtained.

### Comparative Example 1

Cleaning was effected under similar conditions to those of Example 1 except that micro-nano bubbles were not generated. Although it was possible to remove deposits in the microchannels to some extent, it was impossible to remove those adhering to the channel wall surface.

### Example 3

### (1) Microreactor Having a Y-Channel

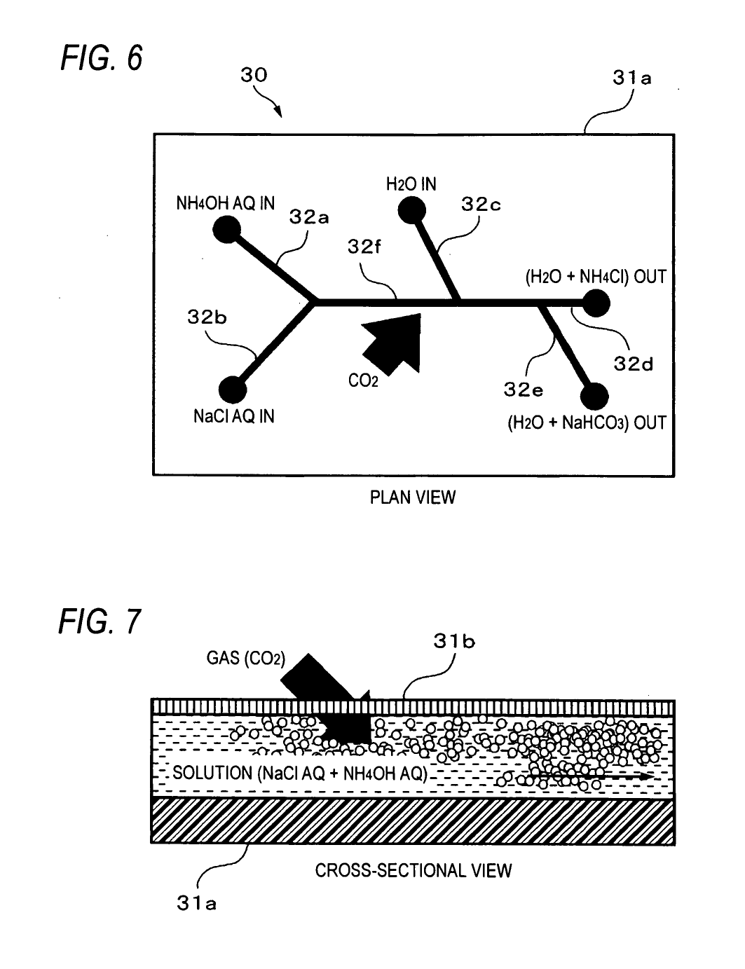

A description will be given of a microreactor 30 having a Y-channel shown in FIGS. 6 and 7. In the microreactor 30, as a base material 31a having a microchannel forming surface shown in FIG. 6, a substrate (40 mm×25 mm×1.0 mm) made of a polydimethylsiloxane (PDMS) resin was used, and the channel width of microchannels 32a to 32e was set to 5,000 μm and their depth was set to 300 μm, while the channel width of a microchannel 32f was set to 800 μm and its depth was set to 350 μml.

Since the PDMS resin has an adsorbing effect, the base material 31a can be sealed merely by pressure contact without an adhesive. Therefore, the possibility of the channels becoming blocked due to the adhesive or the like is small.

In addition, a cover 31b was used in which holes were provided in an anodized silicon substrate (porous silicon with a pore diameter of 5 to 50 nm and a thickness of 300 μm) at portions corresponding to the fluid inlet ports and the outlet port formed at the microchannels 32a to 32e.

The channel forming surface of the base material 31a and the cover 31b were subjected to room-temperature bonding in the same way as in Example 1, to thereby obtain the microreactor 30 having a Y-channel of Example 3.

Since this channel was relatively large, the channel was formed by the simplest “dies cutting.”

### (2) Manufacture of Sodium Hydrogen Carbonate

Sodium hydrogen carbonate was manufactured by using the microreactor 30 by the following operation.

The microreactor 30 with the Y-channel was set in the chamber with the cover 31b placed on the upper side, a CO₂ gas was filled in the chamber, and the pressure within the chamber was adjusted to 1 to 10 Mpa. An NH₄OH aqueous solution (0.1 mol/l) was sent from the microchannel 32a, and an NaCl aqueous solution (0.1 mol/l) was sent from the microchannel 32b both at a flow rate (6 ml/h to 60 ml/h) by the use of syringe pumps, respectively.

After the reaction shown in the equation (a), precipitated particles of sodium hydrogen carbonate were sufficiently cleaned by a laminar flow formed by distilled water introduced through the microchannel 32c at a flow rate (6 to 60 ml/h) by using a syringe pump, and a liquid containing the cleaned sodium hydrogen carbonate was collected at the outlet port formed at a terminal end of the microchannel 32e.

In the case of Example 3, since pressure is constantly applied to the cover 31b from the outside, fluid leakage from the cover 31b does not occur, so that the pore diameter may be of such a size that water molecules can pass therethrough (1,240 nm or greater which is a large size close to the size of a micro bubble). In addition, since CO₂ which passed through the cover 31b assumed the form of micro-nano bubbles, reactivity with components contained in the aqueous solution also excelled, so that the configuration of Example 3 is preferable in comparison with the microreactor 10 of Example 1.

### (3) Cleaning of Microchannel

After the microreactor 30 after use was set in the chamber, and oxygen was filled in the chamber, the pressure within the chamber was adjusted to 12 Mpa or higher.

The cleaning liquid (composition: distilled water at pH=approx. 8) was sent from the fluid inlet ports of the microchannels 32a to 32c at a flow rate (60 to 600 ml/h) by syringe pumps.

As a result of the fact that the cleaning liquid was sent until the flow of the cleaning liquid stabilized, it was possible to remove contaminants (not shown) in the microchannels and deposits (not shown) on the microchannel wall.

### Example 4

Sodium hydrogen carbonate can also be obtained by causing an aqueous solution of sodium hydroxide obtained by subjecting an aqueous solution of sodium chloride to electrolysis to react with carbon dioxide.

2NaCl+2H₂O→2NaOH+Cl₂↑+H₂↑ (b)

NaOH+CO₂→NaHCO₃↓ (c)

In this case, by placing the microreactor in a decompression chamber, the reaction of this equation (b) makes it possible to separate and selectively remove only generated reaction gases such as Cl₂ and H₂ through the porous cover.

In the reaction of the equation (c), high-pressure CO₂ can be supplied to the interior of the channel through the porous cover.

### (1) Microreactor with an I-Channel

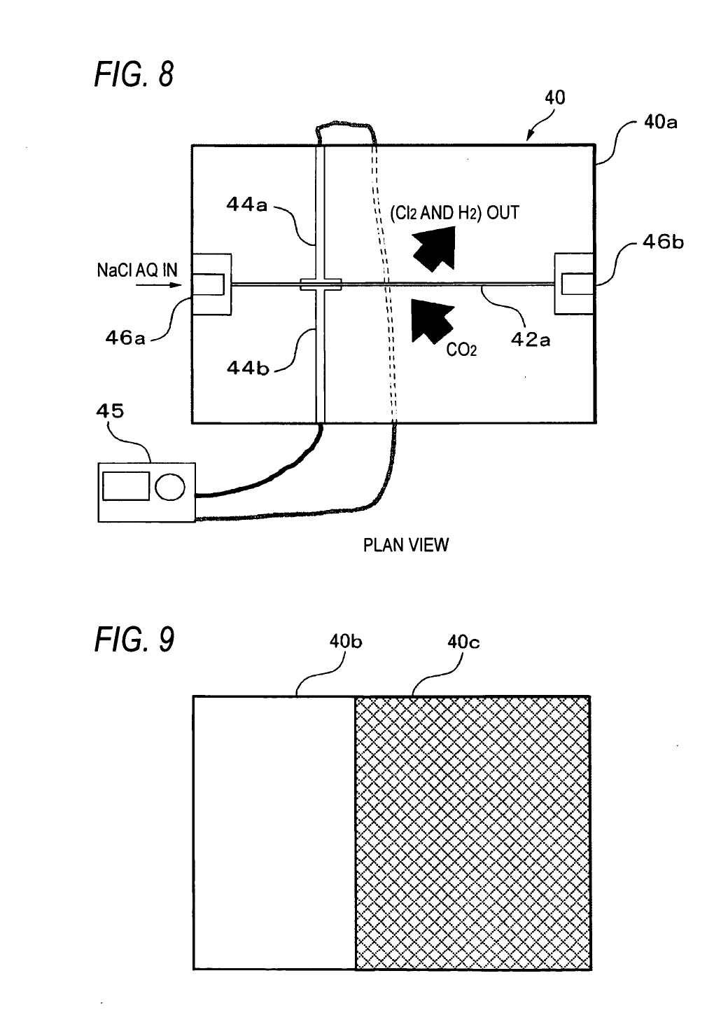

A description will be given of a microreactor 40 with an I-channel shown in FIGS. 8 and 9.

As a base material 40a of the microreactor 40, a glass substrate (5 mm×3 mm×1 mm) having a surface coated with gold plating was used. A microchannel 42a was formed by etching by setting its channel width set to 250 μm and its depth to 300 μm. Electrolysis-use electrodes 44a and 44b made of gold were provided in the microchannel with the microchannel 42a sandwiched therebetween.

In addition, a boehmite-treated aluminum foil was used as a cover 40b, and an anodized aluminum foil (with a pore diameter of 60 nm and a thickness of 300 μm) was used as a cover 40c. A surface of the base material 40a with the microchannel formed therein and the covers 40b and 40c were subjected to room-temperature bonding and transfer to obtain the microreactor 40 with an I-channel of Example 4.

The anodized aluminum coating used in Example 4 was fabricated as described below.

1. The PDMS resin was spin coated on an Si wafer such that the thickness becomes 100 μm to 10 mm or thereabouts, and was cured to thereby form a PDMS layer (release layer).
2. The aluminum foil was laminated on the PDMS layer by roll welding such that creases would not be formed on the wafer.
3. A negative film resist was laminated on the aluminum foil and was subjected to patterning (exposure, development).
4. Only resist openings of the aluminum foil were selectively subjected to anodic oxidation (treatment time: 20 min.).
5. The resist was exfoliated (Note: The anodized aluminum portion underwent a slight increase in volume due to the anodization reaction).
6. The aluminum foil was selectively etched by hydrochloric acid.

### (2) Manufacture of Sodium Hydrogen Carbonate

Sodium hydrogen carbonate was manufactured by using the microreactor 40 by the following operation.

### (Process of Equation (b))

The microreactor 40 with the I-channel was set in the chamber with the cover surface set as an upper surface, and the pressure within the chamber was adjusted to a depressurized atmosphere (10⁻³ Mpa). An NH₄OH aqueous solution (0.1 mol/l) was sent from the microchannel 42a at a flow rate (6 ml/h to 60 ml/h) by the use of a syringe pump, and a voltage of 4.5 to 7.0 V was applied across the electrode 44a and the electrode 44b. Through the reaction of the equation (b), an NaOH aqueous solution was collected at an outlet port 46b formed at a terminal end of the microchannel 42e. (Process of equation (c))

The microreactor 40 with the I-channel of Example 4 was set in the chamber with the cover surface set as an upper surface, the interior of the chamber was filled with the CO₂ gas, and the pressure within the chamber was adjusted to a pressurized atmosphere (15 Mpa). The NaOH aqueous solution collected earlier was sent from a fluid inlet port 46a at a flow rate (60 to 600 ml/h) by a syringe pump, and the CO₂ gas in the form of micro-nano bubbles was supplied to the fluid in the microchannel. After the reaction of the equation (c), an aqueous solution containing sodium hydrogen carbonate was collected at the outlet port 46b.

The reaction of the equation (b) and the equation (c) may be effected continuously by connecting two microreactors with the I-channel of Example 4 which were used in the reaction of the equation (b) and the equation (c). Still alternatively, after the reaction of the equation (b) is carried out as described above and the NaOH aqueous solution is collected, the reaction of the equation (c) may be carried out by using the same microreactor.

### (3) Cleaning and Sterilizing of Microchannels

After the microreactor 40 after use was set in the chamber with the cover 40b and the cover 40c set on the upper side, and oxygen was filled in the chamber, the pressure within the chamber was adjusted to 15 Mpa. A cleaning liquid (composition: distilled water at pH=approx. 8) was sent from the microchannel 42a at a flow rate (60 to 600 ml/h) by a syringe pump. Oxygen in the form of micro-nano bubbles was supplied to the cleaning liquid through the porous wall. As a result of the fact that the cleaning liquid was sent until the flow of the cleaning liquid containing micro-nano bubbles stabilized, it was possible to remove contaminants (not shown) in the microchannels and deposits (not shown) on the microchannel wall.

### Example 5

The sodium hydrogen carbonate (NaHCO₃) obtained in Examples 1 to 4 was heated to obtain sodium carbonate (Na₂CO₃) was obtained by the reaction shown in the following equation (d) (completion of the ammonia soda process).

2NaHCO₃→Na₂CO₃+H₂O+CO₂↑ (d)

### (1) Microreactor with an I-Channel

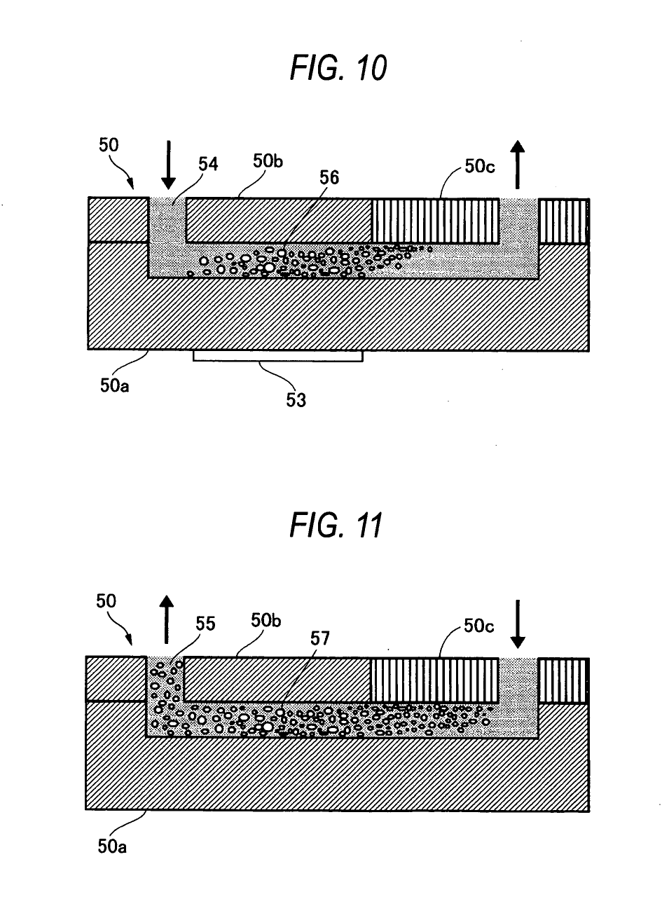

A description will be given of a microreactor 50 with an I-channel shown in FIGS. 10 to 13.

As a base material 50a of the microreactor 50 shown in FIGS. 10 to 13, an SUS-made plate material (40 mm×30 mm×2.5 mm) having a surface coated with gold plating was used. A microchannel 52 was fabricated by half etching of the stainless steel by setting the channel width to 500 μm and the depth to 300 μm.

In addition, an aluminum thin plate (with a thickness of 400 μm) was used as a cover 50b, and an anodized aluminum thin plate (with a pore diameter of 500 nm to 1.2 μm and a thickness of 400 μm) was used as a cover 50c. A surface of the base material 50a with the microchannel formed therein and the covers 50b and 50c were simultaneously subjected to room-temperature bonding.

A heater 53 was installed for the microchannel 52, thereby obtaining the microreactor 50 with the I-channel of Example 5.

### (2) Manufacture of Sodium Hydrogen Carbonate

Sodium hydrogen carbonate was manufactured by using the microreactor 50 by the following operation.

The microreactor 50 with the I-channel was set in the chamber with the covers 50b and 50c set on the upper side, and the pressure within the chamber was adjusted to a depressurized atmosphere (10⁻³ Pa). In addition, the heater 53 was set to 120° C.

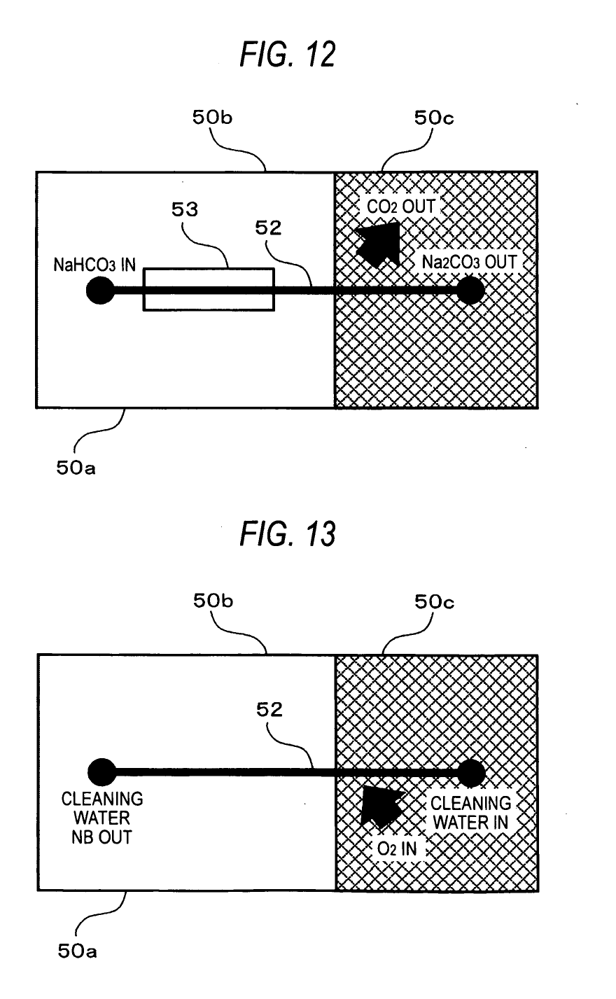

As shown in FIGS. 10 and 12, each NaHCO₃ dispersion liquid 54 obtained in Examples 1 to 4 was sent from the microchannel 52 at a flow rate (6 to 60 ml/h) by the use of a syringe pump. A carbon dioxide gas 56 generated by heating was released to outside the microchannel through the porous wall of the cover 50c.

After the reaction shown in the equation (d), the aqueous solution containing sodium carbonate was collected at the outlet port at a terminal end of the microreactor 52.

### (3) Cleaning of Microchannel

After the microreactor 50 of Example 5 after use was set in the chamber, and oxygen was filled in the chamber, the pressure within the chamber was adjusted to a pressurized atmosphere (13 Mpa).

As shown in FIGS. 11 and 13, a cleaning liquid 55 (composition: distilled water at pH=approx. 8) was sent in an opposite direction to that at the time the manufacture of sodium carbonate from a terminal of the microchannel 52 at a flow rate (100 to 600 ml/h) by a syringe pump. Oxygen 57 in the form of micro-nano bubbles was supplied to the cleaning liquid 55 through the porous wall.

As a result of the fact that the cleaning liquid was sent until the flow of the cleaning liquid 55 stabilized, it was possible to remove contaminants (not shown) in the microchannels and deposits (not shown) on the microchannel wall.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A micro-nano bubble generating method comprising:
introducing a liquid into a microchannel, in which the microchannel is defined by a microchannel wall an entirety or a portion of which is formed by a porous wall having through pores with radii of 10 to 1,000 nm; and
supplying a gas directly into the microchannel from outside the porous wall by a pressurized-gas supplying section, to allow micro-nano bubbles to be contained in the liquid.

2. The micro-nano bubble generating method according to claim 1, further comprising:
applying ultrasonic waves to the liquid within the microchannel by an ultrasonic transducer.

3. A microchannel cleaning method comprising:
introducing a liquid into a microchannel, in which the microchannel is defined by a microchannel wall an entirety or a portion of which is formed by a porous wall having through pores with radii of 10 to 1,000 nm;
preparing a cleaning liquid by allowing micro-nano bubbles to be contained in the liquid by supplying a gas directly into the microchannel from outside the porous wall by a pressurized-gas supplying section; and
effecting cleaning and/or sterilizing an interior of the microchannel by passing the cleaning liquid through a microchannel identical to or different from the microchannel.

4. The microchannel cleaning method according to claim 3,
wherein the microchannel is a microchannel formed in a device selected from the group consisting of a food processing device, a pharmaceutical product processing device, and a chemical reaction device.

5. The microchannel cleaning method according to claim 3,
wherein the micro-nano bubbles comprises at least one gas selected from the group consisting of air, oxygen, and ozone.

6. The microchannel cleaning method according to claim 3,
wherein the cleaning liquid is water at pH 6 to 9 containing the micro-nano bubbles.

7. A micro-nano bubble generating system comprising:
a porous wall having through pores with radii of 10 to 1,000 nm, the porous wall forming an entirety or a portion of a microchannel wall that defines a microchannel;
a pressurized-gas supplying section that supplies a gas directly into the microchannel from outside the porous wall.

8. The micro-nano bubble generating system according to claim 7,
wherein the porous wall is an anodized aluminum coating.

9. A microreactor comprising the micro-nano bubble generating system according to claim 7.
